(19) United States
(12) Patent Application Publication
(10) Pub. No.: US 2025/0098769 A1
(43) Pub. Date: Mar. 27, 2025

(54) AEROSOL GENERATING DEVICE INCLUDING CONCENTRATOR

(71) Applicant: KT&G CORPORATION, Daejeon (KR)

(72) Inventors: Wonkyeong LEE, Guri-si (KR); Min Kyu KIM, Seoul (KR); Pau Joon SUNWOO, Seoul (KR)

(73) Assignee: KT&G CORPORATION, Daejeon (KR)

(21) Appl. No.: 18/568,553

(22) PCT Filed: Aug. 11, 2023
(86) PCT No.: PCT/KR2023/011902

§ 371 Date: Dec. 8, 2023

(30) Foreign Application Priority Data
Aug. 31, 2022 (KR) 10-2022-0109684

(51) Int. Cl. A24F 40/465; A24F 40/10; A24F 40/20; A24F 40/30; A24F 40/42; A24F 40/51; A24F 40/65

(52) U.S. Cl. CPC A24F 40/465; A24F 40/42; A24F 40/10; A24F 40/20; A24F 40/30; A24F 40/51; A24F 40/65

(57) ABSTRACT

The aerosol generating device may include a heating structure configured to generate heat by surface plasmon resonance, and a concentrator configured to focus light on the heating structure.

### TECHNICAL FIELD

The disclosure relates to an aerosol generating device, for example, to an aerosol generating device including a concentrator.

### BACKGROUND ART

Techniques for heating a target by generating heat are being developed. For example, heat may be generated by supplying electrical energy to an electrically resistive element. In another example, heat may be generated by electromagnetic coupling between a coil and a susceptor. The above description is information acquired during the course of conceiving the present disclosure, or already possessed at the time, and is not necessarily art publicly known before the present application was filed.

### DISCLOSURE OF INVENTION

### Technical Problem

One aspect of the disclosure may provide an aerosol generating device that may increase light use efficiency.

### Solution to Problem

An aerosol generating device includes a heater including a substrate, an enclosure disposed on the substrate, a cavity formed by the substrate and the enclosure and configured to accommodate an aerosol generating article, and a beating structure disposed on the substrate and configured to generate heat by surface plasmon resonance, and a concentrator configured to focus light on the heating structure.

The substrate may include a base which defines at least a portion of the cavity, and a flange which extends from the base.

The substrate and the enclosure may include an opaque material.

The substrate may include a thermally conductive material.

The substrate may include a thermally conductive barrier material.

The heating structure may include a plurality of metal particles applied on an outer surface of the substrate.

The heating structure may include a metal prism including a plurality of metal particles.

The metal prism may have a thickness greater than 0 nanometers (nm) and less than or equal to 10 nm.

The heating structure may include a plurality of metal particles applied on a surface of the substrate and an inner surface of the enclosure.

The heater may include a reflector disposed on an inner surface of the enclosure.

The concentrator may include a convex lens.

The aerosol generating device may further include an optical modulator configured to adjust a concentrating area of the concentrator.

The aerosol generating device may further include a light source configured to emit light toward the concentrator.

The aerosol generating device may further include a replaceable cartridge including the substrate, the enclosure, and the heating structure.

A cartridge for an aerosol generating article includes a substrate, an enclosure disposed on the substrate, a cavity formed by the substrate and the enclosure and configured to accommodate an aerosol generating article, and a heating structure disposed on the substrate and configured to generate heat by surface plasmon resonance.

### Advantageous Effects of Invention

According to an embodiment, the size of components (e.g., a battery) in an aerosol generating device may be reduced. According to an embodiment, light use efficiency may be increased. The effects of the aerosol generating device according to an embodiment are not limited to the above-mentioned effects, and other unmentioned effects can be clearly understood from the following description by one of ordinary skill in the art.

### BRIEF DESCRIPTION OF DRAWINGS

The foregoing and other aspects, features, and advantages of embodiments in the disclosure will become apparent from the following detailed description with reference to the accompanying drawings.

FIGS. 1 to 3 are diagrams illustrating examples of an aerosol generating article inserted into an aerosol generating device according to an embodiment.

FIGS. 4 and 5 are diagrams illustrating examples of an aerosol generating article according to an embodiment.

FIG. 6 is a block diagram of an aerosol generating device according to an embodiment.

FIG. 7 is a diagram illustrating an aerosol generating system according to an embodiment.

FIG. 8 is a diagram illustrating a heater according to an embodiment.

FIG. 9 is a diagram illustrating an optical assembly according to an embodiment.

FIG. 10 is a perspective view of a heater according to an embodiment.

FIG. 11 is a plan view of a portion of the heater of FIG. 10 according to an embodiment.

FIG. 12 is a cross-sectional view of the heater of FIG. 11, taken along a line 12-12 according to an embodiment,

FIG. 13 is a diagram illustrating a heater according to another embodiment.

FIG. 14 is a diagram illustrating a heater according to another embodiment.

### MODE FOR THE INVENTION

The terms used in the embodiments are selected from among common terms that are currently widely used, in consideration of their function in the embodiments. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the present disclosure are not merely designations of the terms, but the terms are defined based on the meaning of the terms and content throughout the present disclosure.

It will be understood that when a certain part “includes” a certain component, the part does not exclude another component but may further include another component, unless the context clearly dictates otherwise. Also, terms such as “unit.” “module,” etc., as used in the specification may refer to a part for processing at least one function of operation and may be implemented as hardware, software, or a combination of hardware and software.

As used herein, expressions such as “at least one of.” when preceding a list of elements, modify the entire list of elements and do not modify the individual elements of the list. For example, “at least one of a, b, or c” and “at least one of a, b, and c” should be understood as including only a, only b, only c, both a and b, both a and c, both b and c, or all of a, b, and c.

Hereinafter, embodiments of the present disclosure will be described in detail with reference to the accompanying drawings such that one of ordinary skill in the art may easily practice the present disclosure. The present disclosure may be embodied in many different forms and is not limited to the embodiments described herein.

Hereinafter, embodiments of the present disclosure will be described in detail with reference to the drawings.

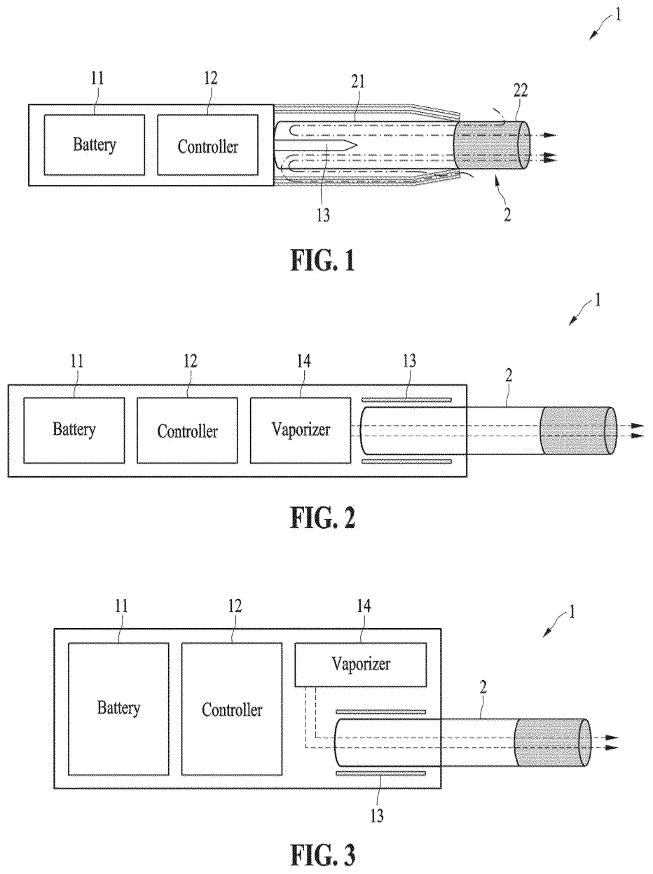

FIGS. 1 to 3 are diagrams illustrating examples of an aerosol generating article inserted into an aerosol generating device according to an embodiment.

Referring to FIG. 1, an aerosol generating device 1 may include a battery 11, a controller 12, and a heater 13. Referring to FIGS. 2 and 3, the aerosol generating device 1 may further include a vaporizer 14. In addition, an aerosol generating article 2 (e.g., a cigarette) may be inserted into an inner space of the aerosol generating device 1.

The aerosol generating device 1 shown in FIGS. 1 through 3 may include components related to the embodiment described herein. Therefore, it is to be understood by one of ordinary skill in the art to which the present disclosure pertains that the aerosol generating device 1 may further include other general-purpose components in addition to the ones shown in FIGS. 1 through 3.

In addition, although it is shown that the heater 13 is included in the aerosol generating device 1 in FIGS. 2 and 3, the heater 13 may be omitted as needed.

FIG. 1 illustrates a linear alignment of the battery 11, the controller 12, and the heater 13. In addition, FIG. 2 illustrates a linear alignment of the battery 11, the controller 12, the vaporizer 14, and the heater 13. In addition, FIG. 3 illustrates a parallel alignment of the vaporizer 14 and the heater 13. However, the internal structure of the aerosol generating device 1 is not limited to what is shown in FIGS. 1 through 3. That is, such alignments of the battery 11, the controller 12, the heater 13, and the vaporizer 14 may be changed depending on the design of the aerosol generating device 1.

When the aerosol generating article 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the aerosol generating article 2 into the user.

Even when the aerosol generating article 2 is not inserted in the aerosol generating device 1, the aerosol generating device 1 may heat the heater 13, as needed.

The battery 11 may supply power to be used to operate the aerosol generating device 1. For example, the battery 11 may supply power to heat the heater 13 or the vaporizer 14, and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the present disclosure pertains that the processor may be implemented in other types of hardware.

The bester 13 may be heated by power supplied by the battery 11. For example, when a cigarette is inserted in the aerosol generating device 1, the heater 13 may be disposed outside the cigarette. The heated heater 13 may thus raise the temperature of an aerosol generating material in the cigarette.

The heater 13 may be an electrically resistive beater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

As another example, the heater 13 may be an induction heater. Specifically, the heater 13 may include an electrically conductive coil for heating the cigarette in an inductive heating manner, and the cigarette may include a susceptor to be heated by the induction heater.

For example, the heater 13 may include a tubular heating element, a plate-shaped heating element, a needle-shaped heating element, or a rod-shaped heating element, and may heat the inside or outside of the aerosol generating article 2 according to the shape of a heating element.

In addition, the heater 13 may be provided as a plurality of heaters in the aerosol generating device 1. In this case, the plurality of heaters 13 may be disposed to be inserted into the aerosol generating article 2 or may be disposed outside the aerosol generating article 2. In addition, some of the plurality of heaters 13 may be disposed to be inserted into the aerosol generating article 2, and the rest may be disposed outside the aerosol generating article 2. However, the shape of the heater 13 is not limited to what is shown in FIGS. 1 through 3 but may be provided in various shapes.

The vaporizer 14 may heat a liquid composition to generate an aerosol, and the generated aerosol may pass through the aerosol generating article 2 into the user. That is, the aerosol generated by the vaporizer 14 may travel along an airflow path of the aerosol generating device 1, and the airflow path may be configured such that the aerosol generated by the vaporizer 14 may pass through the cigarette into the user.

For example, the vaporizer 14 may include a liquid storage, a liquid transfer means, and a beating element. However, embodiments are not limited thereto. For example, the liquid storage, the liquid transfer means, and the heating element may be included as independent modules in the aerosol generating device 1.

The liquid storage may store the liquid composition. For example, the liquid composition may be a liquid including a tobacco-containing material having a volatile tobacco flavor ingredient, or a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit flavor ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin B. However, embodiments are not limited thereto. The liquid composition may also include an aerosol former such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic. However, embodiments are not limited thereto.

The heating element may be an element for heating the liquid composition transferred by the liquid transfer means. The heating element may be, for example, a metal heating wire, a metal beating plate, a ceramic heater, or the like. However, embodiments are not limited thereto. In addition, the beating element may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer. However, embodiments are not limited thereto.

Meanwhile, the aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. In addition, the aerosol generating device 1 may include at least one sensor (e.g., a puff detection sensor, a temperature detection sensor, an aerosol generating article insertion detection sensor, etc.). In addition, the aerosol generating device 1 may be manufactured to have a structure allowing external air to be introduced or internal gas to flow out even while the aerosol generating article 2 is inserted.

Although not shown in FIGS. 1 through 3, the aerosol generating device 1 may constitute a system along with a separate cradle. For example, the cradle may be used to charge the battery 11 of the aerosol generating device 1. Alternatively, the cradle may be used to heat the heater 13, with the cradle and the aerosol generating device 1 coupled.

The aerosol generating article 2 may be similar to a conventional combustible cigarette. For example, the aerosol generating article 2 may be divided into a first portion including an aerosol generating material and a second portion including a filter of the like. Alternatively, the second portion of the aerosol generating article 2 may also include the aerosol generating material. For example, the aerosol generating material provided in the form of granules or capsules may be inserted into the second portion.

The first portion may be entirely inserted into the aerosol generating device 1, and the second portion may be exposed outside. Alternatively, only the first portion may be partially inserted into the aerosol generating device 1, or the first portion may be entirely into the aerosol generating device 1 and the second portion may be partially inserted into the aerosol generating device 1. The user may inhale the aerosol with the second portion in their mouth. In this case, the aerosol may be generated as external air passes through the first portion, and the generated aerosol may pass through the second portion into the mouth of the user.

For example, the external air may be introduced through at least one air path formed in the aerosol generating device 1. In this example, the opening or closing and/or the size of the air path formed in the aerosol generating device 1 may be adjusted by the user. Accordingly, an amount of atomization, a sense of smoking, or the like may be adjusted by the user. As another example, the external air may be introduced into the inside of the aerosol generating article 2 through at least one hole formed on a surface of the aerosol generating article 2.

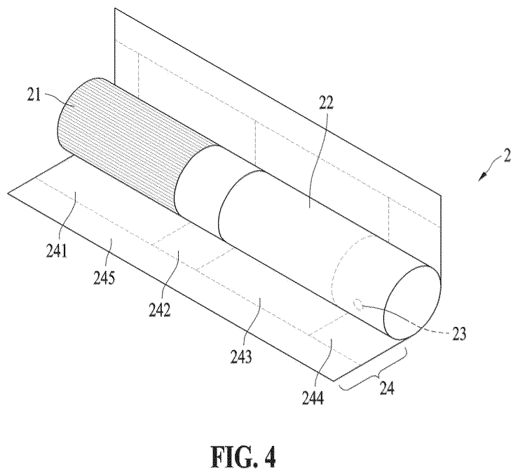

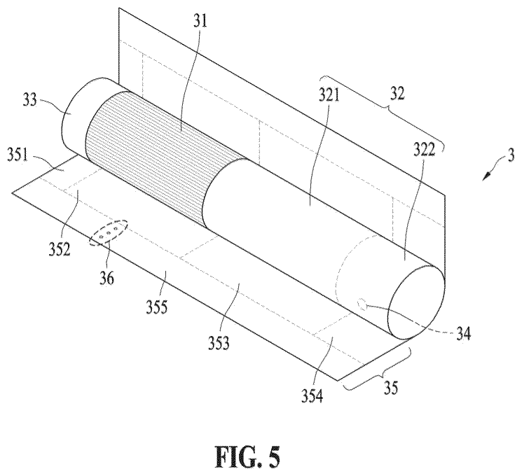

Hereinafter, examples of the aerosol generating article 2 are described with reference to FIGS. 4 and 5.

FIGS. 4 and 5 are diagrams illustrating examples of an aerosol generating article according to an embodiment.

Referring to FIG. 4, the aerosol generating article 2 may include a tobacco rod 21 and a filter rod 22. The first portion and the second portion described above with reference to FIGS. 1 through 3 may include the tobacco rod 21 and the filter rod 22, respectively.

The filter rod 22 is illustrated as having a single segment in FIG. 4. However, embodiments are not limited thereto. That is, alternatively, the filter rod 22 may include a plurality of segments. For example, the filter rod 22 may include a segment that cools an aerosol and a segment that filters a predetermined ingredient contained in an aerosol. In addition, the filter rod 22 may further include at least one segment that performs another function, as needed.

The diameter of the aerosol generating article 2 may be in a range of about 5 millimeters (mm) to about 9 mm, and the length thereof may be about 48 mm. However, embodiments are not limited thereto. For example, the length of the tobacco rod 21 may be about 12 mm, the length of a first segment of the filter rod 22 may be about 10 mm, the length of a second segment of the filter rod 22 may be about 14 mm, and the length of a third segment of the filter rod 22 may be about 12 mm. However, embodiments are not limited thereto.

The aerosol generating article 2 may be wrapped with at least one wrapper 24. The wrapper 24 may have at least one hole through which external air is introduced or internal gas flows out. As an example, the aerosol generating article 2 may be wrapped with one wrapper 24. As another example, the aerosol generating article 2 may be wrapped with two or more wrappers 24 in an overlapping manner. For example, the tobacco rod 21 may be wrapped with a first wrapper 241, and the filter rod 22 may be wrapped with wrappers 242, 243, and 244. In addition, the aerosol generating article 2 may be entirely wrapped again with a single wrapper 245. For example, when the filter rod 22 includes a plurality of segments, the segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. In addition, the first wrapper 241 and the second wrapper 242 may be formed of oilproof paper and/or an aluminum laminated wrapping material.

The third wrapper 243 may be formed of hard wrapping paper. For example, the basis weight of the third wrapper 243 may be in a range of about 88 g/m to about 96 g/m², and may be desirably in a range of about 90 g/m² to about 94 g/m². In addition, the thickness of the third wrapper 243 may be in a range of about 120 micrometers (μm) to about 130 μm, and may be desirably about 125 μm.

The fourth wrapper 244 may be formed of oilproof hard wrapping paper. For example, the basis weight of the fourth wrapper 244 may be in a range of about 88 g/m² to about 96 g/m², and may be desirably in a range of about 90 g/m² to about 94 g/m². In addition, the thickness of the fourth wrapper 244 may be in a range of about 120 g/m² to about 130 μm, and may be desirably about 125 μm.

The fifth wrapper 245 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 245 may be in a range of about 57 g/m² to about 63 g/m², and may be desirably about 60 g/m². In addition, the thickness of the fifth wrapper 245 may be in a range of about 64 μm to about 70 μm, and may be desirably about 67 μm.

The fifth wrapper 245 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 245 without limitation.

The fifth wrapper 245 may prevent the aerosol generating article 2 from burning. For example, there may be a probability that the aerosol generating article 2 burns when the tobacco rod 21 is heated by the bester 13. Specifically, when the temperature rises above the ignition point of any one of the materials included in the tobacco rod 21, the aerosol generating article 2 may burn. Even in this case, it may still be possible to prevent the aerosol generating article 2 from burning because the fifth wrapper 245 includes a non-combustible material.

In addition, the fifth wrapper 245 may prevent a holder 1 from being contaminated by substances produced in the aerosol generating article 2. For example, liquid substances may be produced in the aerosol generating article 2 when the user puffs. For example, as an aerosol generated in the aerosol generating article 2 is cooled by external air, such liquid substances (e.g. moisture, etc.) may be produced. As the aerosol generating article 2 is wrapped with the fifth wrapper 245, the liquid substances generated within the aerosol generating article 2 may be prevented from leaking out of the aerosol generating article 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives such as, for example, a flavoring agent, a wetting agent, and/or an organic acid. In addition, the tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be formed as a sheet or a strand. Alternatively, the tobacco rod 21 may be formed as a pipe tobacco, which is formed of tiny bits cut from a tobacco sheet. In addition, the tobacco rod 21 may be enveloped by a thermally conductive material. The thermally conductive material may be, for example, a metal foil such as aluminum foil. However, embodiments are not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an induction heater. In this case, although not shown, the tobacco rod 21 may further include an additional susceptor in addition to the thermally conductive material enveloping the outside thereof.

The filter rod 22 may be a cellulose acetate filter. However, there is no limit to the shape of the filter rod 22. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of about 2 mm to about 4.5 mm. However, embodiments are not limited thereto.

A desirable length of the first segment may be adopted from a range of about 4 mm to about 30 mm. However, embodiments are not limited thereto. Desirably, the length of the second segment may be 10 mm. However, embodiments are not limited thereto.

The first segment may have a hardness that is adjustable through an adjustment of the content of a plasticizer in the process of manufacturing the first segment. In addition, the first segment may be manufactured by inserting a structure such as a film or a tube of the same or different materials therein (e.g., in the hollow).

A second segment of the filter rod 22 may cool an aerosol generated as the heater 13 heats the tobacco rod 21. The user may thus inhale the aerosol cooled down to a suitable temperature.

The length or diameter of the second segment may be determined in various ways according to the shape of the aerosol generating article 2. For example, a desirable length of the second segment may be adopted from a range of about 7 mm to about 20 mm. Desirably, the length of the second segment may be about 14 mm. However, embodiments are not limited thereto.

The second segment may be manufactured by weaving a polymer fiber. In this case, a flavoring liquid may be applied to a fiber formed of a polymer. As another example, the second segment may be manufactured by weaving a separate fiber to which a flavoring liquid is applied and the fiber formed of the polymer together. As still another example, the second segment may be formed with a crimped polymer sheet.

For example, the polymer may be prepared with a material selected from the group consisting of polyethylene (PE), polypropylene (PP), polyvinyl chloride (PVC), polyethylene terephthalate (PET), polylactic acid (PLA), cellulose acetate (CA) and aluminum foil.

As the second segment is formed with the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment formed with the crimped polymer sheet may be formed of a material having a thickness between about 5 μm and about 300 μm, for example, between about 10 μm and about 250 μm. In addition, the total surface area of the second segment may be between about, 300 mm/mm and about 1000 mm²/mm. Further, an aerosol cooling element may be formed from a material having a specific surface area between about 10 mm²/mg and about 100 mm²/mg.

Meanwhile, the second segment may include a thread containing a volatile flavor ingredient. The volatile flavor ingredient may be menthol. However, embodiments are not limited thereto. For example, the thread may be filled with a sufficient amount of menthol to provide at least 1.5 mg of menthol to the second segment.

A third segment of the filter rod 22 may be a cellulose acetate filter. A desirable length of the third segment may be adopted from a range of about 4 mm to about 20 mm. For example, the length of the third segment may be about 12 mm. However, embodiments are not limited thereto.

The third segment may be manufactured such that a flavor is generated by spraying a flavoring liquid onto the third segment in the process of manufacturing the third segment. Alternatively, a separate fiber to which the flavoring liquid is applied may be inserted into the third segment. An aerosol generated in the tobacco rod 21 may be cooled as it passes through the second segment of the filter rod 22, and the cooled, aerosol may pass through the third segment into the user. Accordingly, when a flavoring element is added to the third segment, the flavor carried to the user may last much longer.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape. However, embodiments are not limited thereto.

Referring to FIG. 5, an aerosol generating article 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied in the tobacco rod 31 during smoking from flowing into an aerosol generating device (e.g., the aerosol generating device 1 of FIGS. 1 through 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The diameter and the total length of the aerosol generating article 3 may correspond to the diameter and the total length of the aerosol generating article 2 of FIG. 4. For example, the length of the front end plug 33 may be about 7 mm, the length of the tobacco rod 31 may be about 15 mm, the length of the first segment 321 may be about 12 mm, and be length of the second segment 322 may be about 14 mm. However, embodiments are not limited thereto.

The aerosol generating article 3 may be wrapped by at least one wrapper 35. The wrapper 35 may have at least one hole through which external air is introduced or internal gas flows out. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the aerosol generating article 3 may be entirely wrapped again with a fifth wrapper 355.

In addition, at least one perforation 36 may be formed in the fifth wrapper 355. For example, the perforation 36 may be formed in an area surrounding the tobacco rod 31. However, embodiments are not limited thereto. The perforation 36 may perform a function of transferring heat generated by the heater 13 shown in FIGS. 2 and 3 to the inside of the tobacco rod 31.

In addition, the second segment 322 may include at least one capsule 34. Here, the capsule 34 may perform a function of generating a flavor or a function of generating an aerosol. For example, the capsule 34 may have a structure in which a liquid containing a fragrance is wrapped with a film. The capsule 34 may have a spherical or cylindrical shape. However, embodiments are not limited thereto.

The first wrapper 351 may be a combination of general filter wrapping paper and a metal foil such as aluminum foil. For example, the total thickness of the first wrapper 351 may be in a range of about 45 μm to about 55 μm, and may be desirably about 50.3 ρm. Further, the thickness of the metal foil of the first wrapper 351 may be in a range of about 6 μm to about 7 μm, and may be desirably about 6.3 μm. In addition, the basis weight of the first wrapper 351 may be in a range of about 50 g/m² to about 55 g/m², and may be desirably about 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto. Further, the thickness of the second wrapper 352 may be in a range of about 70 μm to about 80 μm, and may be desirably about 78 μm. In addition, the basis weight of the second wrapper 352 may be in a range of about 20 g/m² to about 25 g/m², and may be desirably about 23.5 g/m².

For example, the porosity of the third wrapper 353 may be 24000 CU. However, embodiments are not limited thereto. Further, the thickness of the third wrapper 353 may be in a range of about 60 μm to about 70 μm, and may be desirably about 68 nm. In addition, the basis weight of the third wrapper 353 may be in a range of about 20 g/m² to about 25 g/m², and may be desirably about 21 g/m².

The fourth wrapper 354 may be formed with polylactic acid (PLA) laminated paper. Here, the PLA laminated paper may refer to three-ply paper including a paper layer, a PLA layer, and a paper layer. For example, the thickness of the fourth wrapper 354 may be in a range of about 100 μm to about 120 μm, and may be desirably about 110 μm. In addition, the basis weight of the fourth wrapper 354 may be in a range of about 80 g/m² to about 100 g/m², and may be desirably about 88 g/m².

The fifth wrapper 355 may be formed of sterile paper (e.g., MFW). Here, the sterile paper (MPW) may refer to paper specially prepared such that it has enhanced tensile strength, water resistance, smoothness, or the like, compared to general paper. For example, the basis weight of the fifth wrapper 355 may be in a range of about 57 g/m² to about 63 g/m², and may be desirably about 60 g/m². Further, the thickness of the fifth wrapper 355 may be in a range of about 64 μm to about 70 μm, and may be desirably about 67 ρm.

The fifth wrapper 355 may have a predetermined material internally added thereto. The material may be, for example, silicon. However, embodiments are not limited thereto. Silicon may have properties, such as, for example, beat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. The mono denier of a filament of the cellulose acetate tow may be in a range of about 1.0 to about 10.0, and may be desirably in a range of about 4.0 to about 6.0. The mono denier of the filament of the front end plug 33 may be more desirably about 5.0. In addition, a cross section of the filament of the front end plug 33 may be Y-shaped. The total denier of the front end plug 33 may be in a range of about 20000 to about 30000, and may be desirably in a range of about 25000 to about 30000. The total denier of the front end plug 33 may be more desirably 28000.

In addition, as needed, the front end plug 33 may include at least one channel, and a cross section of the channel may be provided in various shapes.

The tobacco rod 31 may correspond to the tobacco rod 21 described above with reference to FIG. 4. Thus, a detailed description of the tobacco rod 31 will be omitted here.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, the mono denier and the total denier of the first segment 321 may be the same as the mono denier and the total denier of the front end plug 33.

The second segment 322 may be formed of cellulose acetate. The mono denier of a filament of the second segment 322 may be in a range of about 1.0 to about 10.0, and may be desirably in a range of about 8.0 to about 10.0. The mono denier of the filament of the second segment 322 may be more desirably 9.0. In addition, a cross section of the filament of the second segment 322 may be Y-shaped. The total denier of the second segment 322 may be in a range of about 20000 to about 30000, and may be desirably 25000.

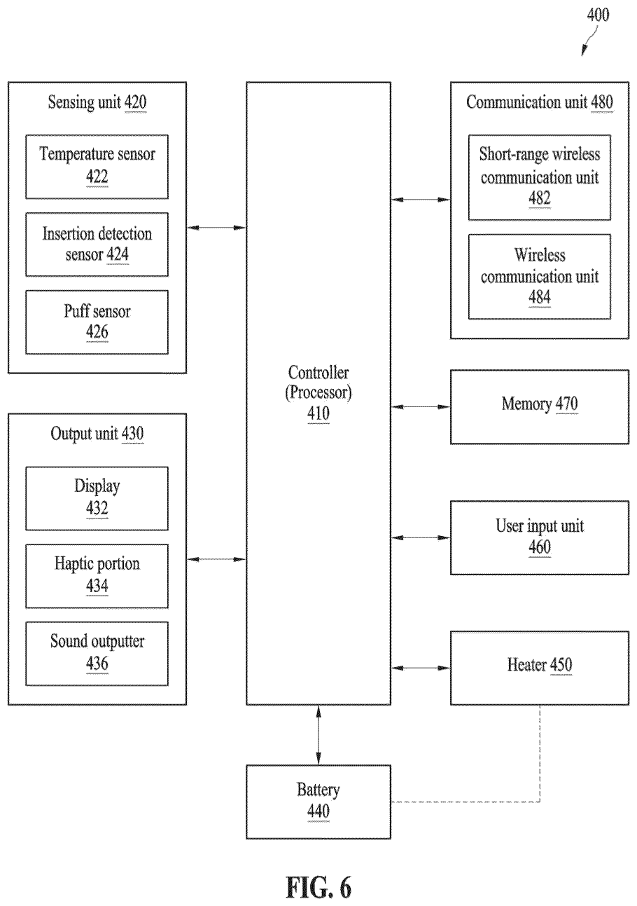

FIG. 6 is a block diagram of an aerosol generating device according to an embodiment.

An aerosol generating device 400 may include a controller 410, a sensing unit 420, an output unit 430, a battery 440, a heater 450, a user input unit 460, a memory 470, and a communication unit 480. However, the internal structure of the aerosol generating device 400 is not limited to what is shown in FIG. 6. It is to be understood by one of ordinary skill in the art to which the present disclosure pertains that some of the components shown in FIG. 6 may be omitted or new components may be added according to the design of the aerosol generating device 400.

The sensing unit 420 may sense a state of the aerosol generating device 400 or a state of an environment around the aerosol generating device 400, and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted, display a notification, and perform other functions.

The sensing unit 420 may include at least one of a temperature sensor 422, an insertion detection sensor 424, or a pull sensor 426. However, embodiments are not limited thereto.

The temperature sensor 422 may sense a temperature at which the heater 450 for an aerosol generating material) is heated. The aerosol generating device 400 may include a separate temperature sensor for sensing the temperature of the heater 450, or the heater 450 itself may perform a function as a temperature sensor. Alternatively, the temperature sensor 422 may be arranged around the battery 440 to monitor the temperature of the battery 440.

The insertion detection sensor 424 may sense whether the aerosol generating article is inserted or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion or removal of the aerosol generating article.

The puff sensor 426 may sense a puff from a user based on various physical changes in an airflow path or airflow channel. For example, the puff sensor 426 may sense the puff of the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 422 through 426 described above. A function of each sensor may be intuitively inferable from its name by one of ordinary skill in the art, and thus, a more detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal item detected) of the aerosol generating device 400, or the like, and the display 432 may externally output the information. The display 432 may be, for example, a liquid crystal display panel (LCD), an organic light-emitting display panel (OLED), or the like. The display 432 may also be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. In addition, the battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 6, the aerosol generating device 400 may further include a power conversion circuit (e.g., a direct current (DC)-to-DC (DC/DC) converter) that converts power of the battery 440 and supplies the power to the heater 450. In addition, when the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 6, the aerosol generating device 400 may further include a power conversion circuit, for example, a low dropout (LDO) circuit or a voltage regulator circuit, which converts power of the battery 440 and supplies the power to respective components.

According to an embodiment, the heater 450 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 450 may be implemented as a metal heating wire, a metal beating plate on which an electrically conductive track is arranged, a ceramic beating element, or the like. However, embodiments are not limited thereto.

According to an embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating the aerosol generating article and a second heater for heating liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 6, the aerosol generating device 400 may further include a connection interface such as a universal serial bus (USB) interface, and may be connected to another external device through the connection interface such as a USB interface to transmit and receive information or to charge the battery 440.

The memory 470, which is hardware for storing various pieces of data processed in the aerosol generating device 400, may store data processed by the controller 410 and data to be processed thereby. The memory 470 may include at least one type of storage medium of a flash memory type memory, a hard disk type memory, a multimedia card micro type memory, a card type memory (e.g., an SD or XE memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile, data associated with a smoking pattern of the user, or the like.

The communication unit 480 may include at least one component for communicating with another electronic device. For example, the communication unit 480 may include a short-range communication unit 482 and a wireless communication unit 484.

The short-range wireless communication unit 482 may include a Bluetooth communication unit, a BLE communication unit, a near field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communicator 484 may include, for example, a cellular network communicator, an Internet communicator, a computer network (e.g., a local area network (LAN) or a wide-area network (WAN) communicator, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the present disclosure pertains that it may be implemented in other types of hardware.

The controller 410 may control the temperature of the heater 450 by controlling the supply of power from the battery 440 to the heater 450. For example, the controller 410 may control the supply of power by controlling the switching of a switching element between the battery 440 and the heater 450. In another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. As another example, the controller 410 may control an amount of power to be supplied to the heater 450 and a time for which the power is to be supplied, such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when the number of puffs counted through the puff sensor 426 reaches a preset number, the controller 410 may inform the user that the aerosol generating device 400 is to be ended soon, through at least one of the display 432, the haptic portion 434, or the sound outputter 436.

According to an embodiment, the controller 410 may control a power supply time and/or a power supply amount for the heater 450 according to a state of the aerosol generating article sensed by the sensing unit 420. For example, when the aerosol generating article (e.g., an aerosol generating article 201) is in an over-humidified state, the controller 410 may control the power supply time for an inductive coil to increase a preheating time, compared to a case where the aerosol generating article is in a general state.

One embodiment may also be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

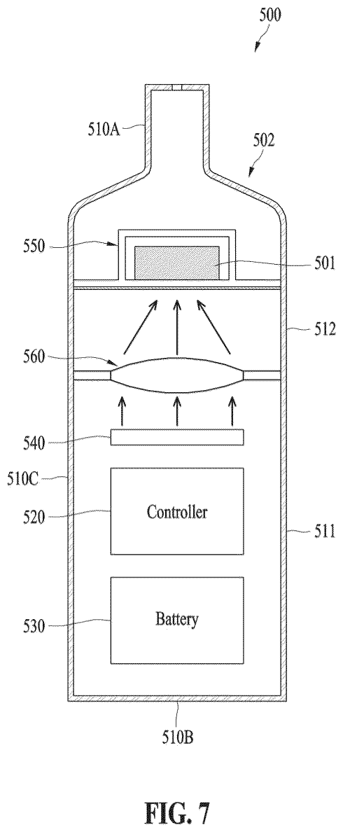

FIG. 7 is a diagram illustrating an aerosol generating system according to an embodiment.

Referring to FIG. 7, an aerosol generating system 500 may include an aerosol generating article 501 (e.g., the aerosol generating article 2 of FIGS. 1 to 4 and/or the aerosol generating article 3 of FIG. 5) and an aerosol generating device 502 (e.g., the aerosol generating device 1 of FIOS. 1 to 3 and/or the aerosol generating device 400 of FIG. 6).

In an embodiment, the aerosol generating device 302 may include a housing 510. The housing 510 may include a first end portion 510A (e.g., a mouth end portion), a second end portion 510B (e.g., a device end portion) opposite to the first end portion 510A, and an extension 510C between the first end portion 510A and the second end portion 510B.

In an embodiment, the width or diameter of the first end portion 510A may be less than the width or diameter of the extension 510C. In an embodiment not shown, the width or diameter of the first end portion 510A may be substantially the same as the width or diameter of the extension 510C.

In an embodiment, the housing 510 may include a plurality of parts. For example, the housing 510 may include a device part 511 and a cartridge 512. The device part 511 may include the second end portion 510B. The device part 511 may include at least a portion of the extension 510C. The cartridge 512 may include the first end portion 510A. The cartridge 512 may include at least a portion of the extension 510C.

In an embodiment, the device part 511 may include a controller 520, a battery 530, a light source 540, and an optical assembly 560, and the cartridge 512 may include a heater 550. In another embodiment, the device part 511 may include the controller 520, the battery 530, and the light source 540, and the cartridge 512 may include the heater 550 and the optical assembly 560.

In an embodiment, the cartridge 512 may be detachably coupled to the device part 511. The cartridge 512 may be replaced with a new cartridge (not shown).

In an embodiment, the aerosol generating device 502 may include the controller 520 (e.g., the controller 12 of FIGS. 1 to 3 and/or the controller 410 of FIG. 6).

In an embodiment, the aerosol generating device 502 may include the battery 530 (e.g., the battery 11 of FIGS. 1 to 3 and/or the battery 440 of FIG. 6).

In an embodiment, the aerosol generating device 502 may include the light source 540. The light source 540 may be configured to generate light. For example, the light source 540 may include at least one or a combination of a light-emitting diode (LED), a laser light source, or any suitable light generating device.

In an embodiment, the aerosol generating device 502 may not include the light source 540. Instead, the aerosol generating device 502 may use light external to the housing 510.

In an embodiment, the light source 540 may be configured to transmit light in an ultraviolet band, a visible band (e.g., about 380 nanometers (nm) to about 780 nm) and/or an infrared band.

In an embodiment, the light source 540 may be configured to generate light having a wavelength for generating surface plasmon resonance (SPR) of a metal particle. The light source 540 may generate light in a wavelength band corresponding to the average maximum absorbance according to the type of the metal particle. In an embodiment in which the metal particle is gold (Au), the light source 540 may generate light having a wavelength of about 600 nm to about 650 nm. In an embodiment in which the metal particle is silver (Ag), the light source 540 may generate light having a wavelength of about 420 μm to about 470 mm.

In an embodiment, the aerosol generating device 502 may include a plurality of light sources 540. The plurality of light sources 540 may be implemented as light sources of the same type. Alternatively, at least a portion of the plurality of light sources 540 may be implemented as different types of light sources.

In an embodiment, the plurality of light sources 540 may be configured to generate light substantially at the same time. Alternatively, at least one of the plurality of light sources 540 may be generate light at a different time.

In an embodiment, the plurality of light sources 540 may be configured to generate light for substantially the same time. Alternatively, the irradiation time of at least one light source 540 of the plurality of light sources 540 may be different from the irradiation time of another light source 540.

In an embodiment, the plurality of light sources 540 may be configured to generate light of substantially the same wavelength band. Alternatively, at least one of the plurality of light sources 540 may generate light having a different wavelength band.

In an embodiment, the plurality of light sources 540 may be configured to generate light with substantially the same illuminance. Alternatively, the illuminance of at least one of the plurality of light sources 540 may be different from the illuminance of another light source 540.

In an embodiment, the aerosol generating device 502 may include a heater 550 (e.g., the heater 13 of FIGS. 1 to 3 and/or the heater 450 of FIG. 4). The heater 550 may be configured to heat the aerosol generating article 501.

In an embodiment, the aerosol generating device 502 may include the optical assembly 560. The optical assembly 560 may be configured to transmit light to the heater 550. For example, the optical assembly 560 may be configured to transmit external light and/or light from the light source 540 to the heater 550.

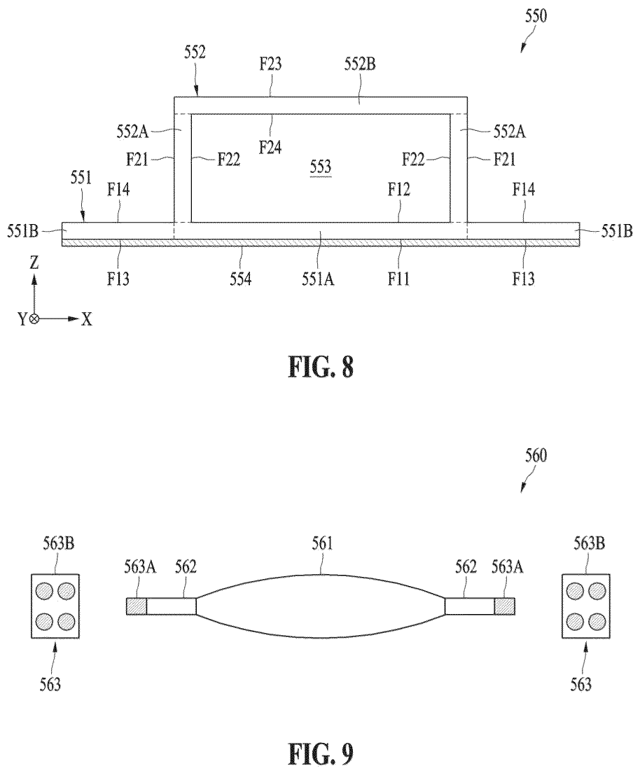

FIG. 8 is a diagram illustrating a heater according to an embodiment.

Referring to FIG. 8, a heater 550 may include a substrate 551. The substrate 551 may include a base 551A. The base 551A may include a first base surface F11 (e.g., a surface in the −Z direction of FIG. 8) and a second base surface F12 (e.g., a surface in the +Z direction of FIG. 8) opposite to the first base surface F11.

In an embodiment, the substrate 551 may include a flange 551B. The flange 551B may include a first flange surface F13 (e.g., a surface in the −Z direction of FIG. 8), and a second flange surface F14 (e.g., a surface in the +Z direction of FIG. 8) opposite to the first flange surface F13. The flange 551B may extend or expand from the base 551A in a first direction (e.g., X-axis direction).

In an embodiment, the base 551A and the flange 551B may be integrally and seamlessly connected to each other.

In an embodiment, the first base surface F11 and the first flange surface F13 may be on substantially the same plane. The second base surface F12 and the second flange surface F14 may be on the substantially same plane.

In an embodiment, the substrate 551 may include a thermally conductive material. The thermally conductive material may have a relatively high thermal conductivity. For example, the thermally conductive material may have a thermal conductivity of about 1 watt per meter-kelvin (W/mK) or greater at 1 bar and a temperature of 25° C. In an embodiment, the substrate 551 may include at least one or a combination of silicon (Si), silicon oxide (SiO₂), sapphire, polystyrene, polymethyl methacrylate, or any other material suitable for thermal conduction. The thermally conductive material may result in overall heating of the substrate 551.

In an embodiment, the substrate 551 may include a thermally conductive barrier material. The thermally conductive barrier material may have a relatively low thermal conductivity. For example, the thermally conductive barrier material may have a thermal conductivity of less than about 1 W/mK at 1 bar and a temperature of 25° C. In an embodiment, the substrate 551 may include glass. The thermally conductive barrier material may result in localized heating of the substrate 551.

In an embodiment, the base 551A may include the thermally conductive material, and the flange 551B may include the thermally conductive barrier material. In an embodiment, the base 551A may include the thermally conductive barrier material and the flange 551B may include the thermally conductive material. In an embodiment, a partial area of the base 551A may include the thermally conductive material and other areas thereof may include the thermally conductive barrier material. In an embodiment, a partial area of the flange 551B may include the thermally conductive material and other areas thereof may include the thermally conductive barrier material.

In an embodiment, the substrate 551 may include an opaque material. The opaque material may substantially reduce light scattering of the substrate 551. In an embodiment, the substrate SSI may include a translucent material. In an embodiment, the substrate 551 may include a transparent material.

In an embodiment, the base 551A may include an opaque material, a translucent material, or a transparent material. In an embodiment, a partial area of the base 551A may include any one of an opaque material, a translucent material, or a transparent material and other areas of the base 551A may include another of an opaque material, a translucent material, or a transparent material.

In an embodiment, the flange 551B may include an opaque material, a translucent material, or a transparent material. In an embodiment, a partial area of the flange 551B may include any one of an opaque material, a translucent material, or a transparent material and other areas of the flange 551B may include another of an opaque material, a translucent material, or a transparent material.

In an embodiment, the heater 550 may include an enclosure 552. The enclosure 552 may include a first enclosure portion 552A. The first enclosure portion 552A may extend from the second base surface F12. The first enclosure portion 552A may extend in a second direction (e.g., the Z-axis direction) intersecting with (e.g., perpendicular to) the first direction (e.g., the X-axis direction). The first enclosure portion 552A may include a first outer enclosure surface F21 and a first inner enclosure surface F22 opposite to the first outer enclosure surface F21.

In an embodiment, the base 551A and the first enclosure portion 552A may be integrally and seamlessly connected to each other.

In an embodiment not shown, the first enclosure portion 552A may extend from the second flange surface F14 in the second direction (e.g., the +/−Z direction). The flange 551B and the first enclosure portion 552A may be integrally and seamlessly connected to each other.

In an embodiment, the enclosure S52 may include a second enclosure portion 552B.

The second enclosure portion 552B may be connected to the first enclosure portion 552A. The second enclosure portion 552B may extend in the first direction (e.g., the X-axis direction). The second enclosure portion 552B may include a second outer enclosure surface F23 and a second inner enclosure surface F24 opposite to the second outer enclosure surface F23.

In an embodiment, the first enclosure portion 552A and the second enclosure portion 552B may be integrally and seamlessly connected to each other.

In an embodiment, the enclosure 552 may include a thermally conductive material. The thermally conductive material may have a relatively high thermal conductivity. For example, the thermally conductive material may have a thermal conductivity of about 1 W/mK or greater at a pressure of 1 bar and a temperature of 25° C. In an embodiment, the enclosure 552 may include at least one or a combination of Si, SiO₂, sapphire, polystyrene, polymethyl methacrylate, or any other material suitable for thermal conduction.

In an embodiment, the enclosure 552 may include a thermally conductive barrier material. The thermally conductive barrier material may have a relatively low thermal conductivity. For example, the thermally conductive barrier material may have a thermal conductivity of less than about 1 W/mK at a pressure of 1 bar and a temperature of 25° C. In an embodiment, the enclosure 552 may include glass.

In an embodiment, the first enclosure portion 552A may include the thermally conductive material and the second enclosure portion 552B may include the thermally conductive barrier material. In an embodiment, the first enclosure portion 552A may include the thermally conductive barrier material and the second enclosure portion 552B may include the thermally conductive material.

In an embodiment, the enclosure 552 may include an opaque material. The opaque material may substantially reduce light scattering of the enclosure 552. In an embodiment, the enclosure 552 may include a translucent material. In an embodiment, the enclosure 552 may include a transparent material.

In an embodiment, the first enclosure portion 552A may include an opaque material, a translucent material, or a transparent material. In an embodiment, a partial area of the first enclosure portion 552A may include any one of an opaque material, a translucent material, or a transparent material and other areas of the first enclosure portion 552A may include another of an opaque material, a translucent material, or a transparent material.

In an embodiment, the second enclosure portion 552B may include an opaque material, a translucent material, or a transparent material. In an embodiment, a partial area of the second enclosure portion 552B may include any one of an opaque material, a translucent material, or a transparent material and other areas of the second enclosure portion 352B may include another of an opaque material, a translucent material, or a transparent material.

In an embodiment, the heater 550 may include a cavity 553. The cavity 553 is configured to accommodate an aerosol generating article (e.g., the aerosol generating article 2 of FIGS. 1 to 4, the aerosol generating article 3 of FIG. 5, and/or the aerosol generating article 501 of FIG. 7). The cavity 553 may be defined by the second base surface F12, the first inner enclosure surface F22, and the second inner enclosure surface F24.

In an embodiment, the heater 550 may include a heating structure 554. The heating structure 554 may be configured to generate beat by surface plasmon resonance (SPR) which refers to the collective oscillation of electrons propagating along an interface of metal particles with a medium. For example, the collective oscillation of electrons of metal particles may be caused by light from the outside of the heating structure 554. The excitation of electrons of metal particles may generate thermal energy, and the generated thermal energy may be transferred within an environment where the heating structure 554 is present. In an embodiment, the heating structure 554 may be disposed on the first base surface F11. In an embodiment, the heating structure 554 may be disposed on the first flange surface F13. In an embodiment, the heating structure 554 may include a plurality of metal particles.

FIG. 9 is a diagram illustrating an optical assembly according to an embodiment.

Referring to FIG. 9, an optical assembly 560 may include a lens 561. The lens 561 may be configured to focus light incident on the lens 561 on one area (e.g., a concentrating area). For example, the lens 561 may include a convex lens.

In an embodiment, the optical assembly 560 may include a support body 562. The support body 562 may be configured to support the lens 561. The support body 562 may be connected to a non-effective area (e.g., a side area) among the areas of the lens 561, through which light does not pass.

In an embodiment, the optical assembly 560 may include an optical modulator 563. The optical modulator 563 may be configured to change the position of the concentrating area. For example, the optical modulator 563 may include a first electromagnetic element 563A (e.g., a magnet) disposed on the support body 562 and a, second electromagnetic element 563B (e.g., a coil) configured to electromagnetically couple with the first electromagnetic element 563A.

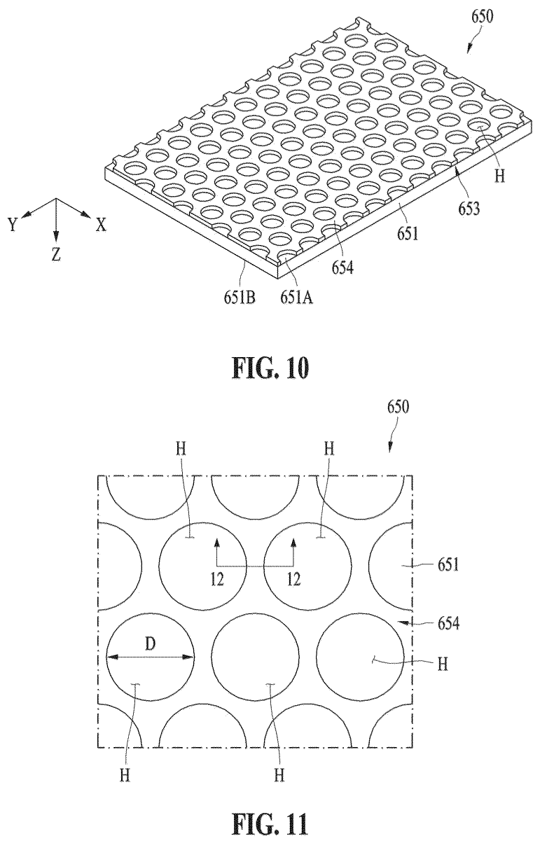

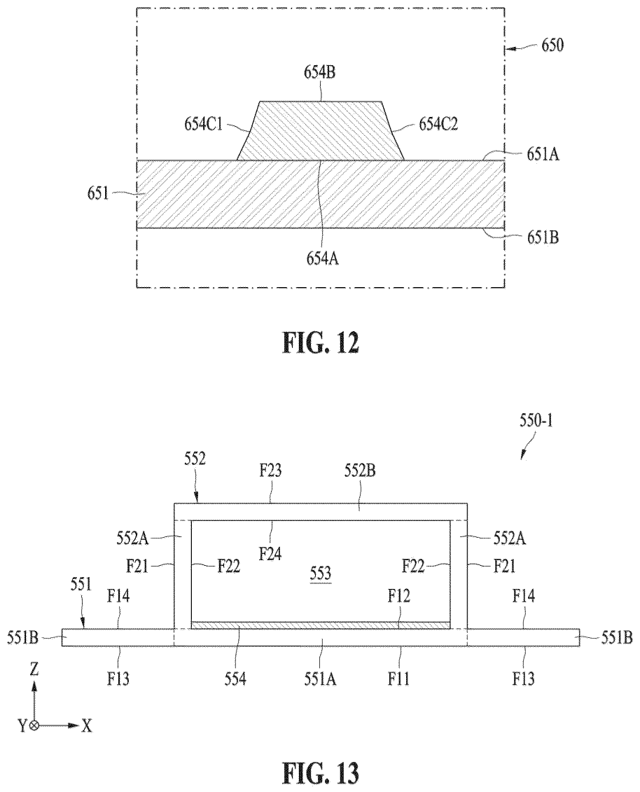

FIG. 10 is a perspective view of a heater according to an embodiment. FIG. 1l is a plan view of a portion of the heater of FIG. 10 according to an embodiment. FIG. 12 is a cross-sectional view of the heater of FIG. 11, taken along a line 12-12 according to an embodiment.

Referring to FIGS. 10 to 12, a beater 650 may include a substrate 651 (e.g., the substrate 531 of FIG. 8). The substrate 651 may include a first substrate surface 651A (e.g., the first base surface F1 and/or the first flange surface F13 of FIG. 8) and a second substrate surface 651B (e.g., the second base surface F12 and/or the second flange surface F14 of FIG. 8) opposite to the first substrate surface 651A.

In an embodiment, the substrate 651 may include a thermally conductive material. For example, the substrate 651 may include Si, SiO₂, sapphire, polystyrene, polymethyl methacrylate, and/or any other material suitable for thermal conduction. In an embodiment, the substrate 651 may include a thermally conductive barrier material. For example, the substrate 651 may include glass.

In an embodiment, the substrate 651 may include an electrically conductive material. In an embodiment, the substrate 651 may include an electrically insulating material.

In an embodiment, the substrate 651 may have various thermal conductivities. For example, the substrate 651 may have a thermal conductivity of about 0.6 W/mK or less, about 1 W/mK to about 2 W/mK, about 2 W/mK to about 5 W/mK, about 5 W/mK to about 10 W/mK, about 10 W/mK to about 100 W/mK, or about 100 W/mK to about 200 W/mK at a pressure of 1 bar and a temperature of 25° C.

In an embodiment, the heater 650 may include a heating structure 653. The heating structure 653 may include a plurality of metal particles. The plurality of metal particles may be nanoscale. For example, the plurality of metal particles may have an average maximum diameter of about 1 μm or less. In an embodiment, the plurality of metal particles may have an average maximum diameter of about 700 nm or less, about 600 om or less, about 500 om or less, about 400 nm or less, about 300 nm or less, about 200 nm or less, about 150 nm or less, or about 100 nm or less.

In an embodiment, the plurality of metal particles may be formed of any material suitable for generating heat. For example, the plurality of metal particles may include at least one of gold, silver, copper, palladium, platinum, aluminum, titanium, nickel, chromium, iron, cobalt, manganese, rhodium, and ruthenium, or a combination thereof.

In an embodiment, the plurality of metal particles may be formed of any material suitable for generating heat by interacting with light of a determined wavelength band (e.g., a visible light wavelength band, that is, about 380 mm to about 780 nm). The plurality of metal particles may include at least one of gold, silver, copper, palladium, or platinum, or a combination thereof.

In an embodiments, the plurality of metal particles may be formed of a metal material having an average maximum absorbance. The average maximum absorbance may be defined as a peak value of absorbance that varies according to a wavelength band of light. A wavelength band in which the plurality of metal particles resonate may include a wavelength band that causes the average maximum absorbance. The plurality of metal particles may be formed of a metal material having an average maximum absorbance in a wavelength band between about 430 om and about 450 nm, between about 480 nm and about 500 nm, between about 490 nm and about 510 nm, between about 500 nm and about 520 nm, between about 550 nm and about 570 nm, between about 600 nm and about 620 nm, between about 620 nm and about 640 nm, between about 630 nm and about 650 nm, between about 640 nm and about 660 nm, between about 680 nm and about 700 nm, or between about 700 nm and about 750 μm. The average maximum absorbance of the plurality of metal particles may vary depending on the metal type, the type of the substrate 651, the size of a structure (e.g., a metal prism) formed by the plurality of metal particles, and/or the shape of the structure. For example, gold may have maximum absorbance in a wavelength range of about 600 nm to about 650 nm. For example, silver may have maximum absorbance in a wavelength range of about 420 nm to about 570 nm.

In an embodiment, the deposition thickness of the plurality of metal particles may be about 10 nm or less. When the plurality of metal particles is deposited on a substrate in a thickness greater than 10 nm, an exothermic reaction may be reduced in the structure (e.g., the metal prism) formed by the plurality of metal particles. When the thickness of the structure formed by the plurality of metal particles exceeds 10 om, the possibility of heat loss to the surroundings of the heater 650 may increase, and thus, the thermal efficiency of the heater 650 may decrease.

In an embodiment, the heating structure 653 may include a metal prism 654 including a plurality of metal particles. The metal prism 654 may be formed as a substantially single structure. The metal prism 654 may include a plurality of holes H.

In an embodiment, the metal prism 654 may include a first base surface 654A facing the first substrate surface 651A of the substrate 651, a second base surface 654B opposite to the first base surface 654A, and a plurality of side surfaces 654C1 and 654C2 between the first base surface 654A and the second base surface 654B. The first substrate surface 651A and the plurality of side surfaces 654C1 and 654C2 may define the plurality of holes H.

In an embodiment, the first base surface 654A and the second base surface 654B may be substantially parallel to each other.

In an embodiment, the first base surface 654A and/or the second base surface 654B may be formed as a substantially flat surface.

In an embodiment, the distance between the first base surface 654A and the second base surface 654B (e.g., the thickness of the metal prism 654) may be about 10 nm or less. When the metal prism 654 has a thickness exceeding 10 nm, the exothermic reaction of a plurality of metal particles forming the metal prism 654 may decrease, and consequently, the thermal efficiency of the heater 650 may decrease.

In an embodiment, the plurality of side surfaces 654C1 and 654C2 of the metal prism 654 may face different directions. For example, the first side surface 654C1 may face a first direction (e.g., a first radial direction) and the second side surface 654C2 may face a second direction (e.g., a second radial direction) substantially opposite to the first direction.

In an embodiment, at least one side surface of the plurality of side surfaces 654C1 and 654C2 may be formed as a substantially curved surface. In an embodiment, the plurality of side surfaces 654C1 and 654C2 may be formed as curved surfaces having substantially the same curvature. In an embodiment, the curvature of any one of the plurality of side surfaces 654C1 and 654C2 may be different from the curvature of another side surface.

In an embodiment, the plurality of side surfaces 654C1 and 654C2 may be formed as curved surfaces that are concave toward the center of the metal prism 654. In an embodiment, at least one side surface of the plurality of side surfaces 654C1 and 654C2 may be formed as a curved surface that is convex from the center of the metal prism 654.

In an embodiment, the metal prism 654 may include two side surfaces. For example, the metal prism 654 may have a substantially semicircular shape or a shape close to a semicircle.

In an embodiment, a portion of holes H among the plurality of holes H may be separated from each other. The portion of holes H may be separated by a portion of the metal prism 654. In an embodiment, the portion of boles H among the plurality of holes H may be connected to each other. In this case, two of the metal prism 654 may not be connected to each other, and may be separated by the holes H which are connected to each other.

In an embodiment, the plurality of holes H may have an average maximum diameter D of about 10 nm or greater, about 50 nm or greater, about 90 nm or greater, about 100 nm or greater, about 150 nm or greater, about 200 nm or greater, about 300 μm or greater, about 350 nm or greater, about 450 nm or greater, or about 500 nm or greater.

In an embodiment, the plurality of holes H may have an average maximum diameter D of about 1,000 nm or less, about 900 nm or less, about 800 nm or less, about 700 nm or less, about 600 nm or less, or about 550 om or less.

FIG. 13 is a diagram illustrating a heater according to an embodiment.

Referring to FIG. 13, a heater 550-1 (e.g., the heater 550 of FIG. 8) may include a substrate 551, an enclosure 552, a cavity 553, and a heating structure 554. The substrate 551 may include a base 551A and a flange 551B. The base 551A may include a first base surface F11 and a second base surface F12. The flange 551B may include a first flange surface F13 and a second flange surface F14. The enclosure 552 may include a first enclosure portion 552A a second enclosure portion 552B. The first enclosure portion 552A may include a first outer enclosure surface F21 and a first inner enclosure surface F22. The second enclosure portion 552B may include a second outer enclosure surface F23 and a second inner enclosure surface F24. In the present embodiment, as compared to the embodiment of FIG. 8, the heating structure 554 may be disposed on the second base surface F12. Alternatively or additionally, the heating structure 554 may be disposed on the first inner enclosure surface F22 and/or the second inner enclosure surface F24.

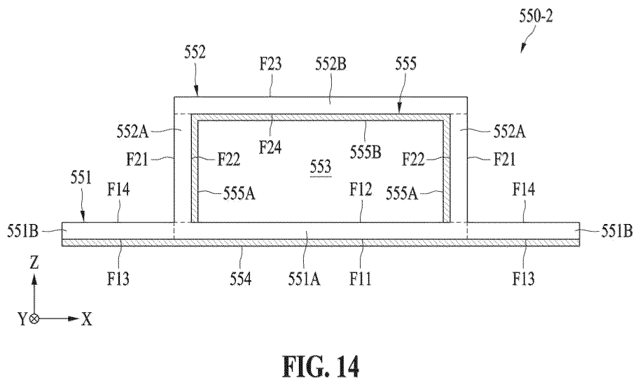

FIG. 14 is a diagram illustrating a heater according to another embodiment.

Referring to FIG. 14, a heater 550-2 (e.g., the heater 550 of FIG. 8 and/or the heater 550-1 of FIG. 13) may include a substrate 551, an enclosure 552, a cavity 553, and a heating structure 554. The substrate S51 may include a base 551A and a flange 551B. The base 551A may include a first base surface FIL and a second base surface F12. The flange 551B may include a first flange surface F13 and a second flange surface F14. The enclosure 552 may include a first enclosure portion 552A a second enclosure portion 552B. The first enclosure portion 552A may include a first outer enclosure surface F21 and a first inner enclosure surface F22. The second enclosure portion 552B may include a second outer enclosure surface F23 and a second inner enclosure surface F24.

In the present embodiment, as compared to the embodiment of FIG. 8, the heater 550-2 may include a reflecting body 555. The reflecting body 555 may be configured to reflect light passing through the substrate SSI back to the heating structure 554. The reflecting body 555 may increase the thermal efficiency of the heater 550 by increasing the light use efficiency of the heating structure 554.

In an embodiment, the reflecting body 555 may include a first reflective layer 555A. The first reflective layer 555A may be disposed on the first inner enclosure surface F22.

In an embodiment, the reflecting body 555 may include a second reflective layer 555B. The second reflective layer 555B may be disposed on the second inner enclosure surface F24.

In an embodiment, the first reflective layer 555A and the second reflective layer 555B may be integrally and seamlessly connected to each other. Alternatively, the first reflective layer 555A and the second reflective layer 555B may be separately connected to each other.

In an embodiment, the reflecting body 555 may include any material suitable for reflecting light. For example, the reflecting body 555 may include at least one of gold, silver, copper, or any other metal material suitable for light reflection, or a combination thereof.

In an embodiment, the first reflective layer 555A and the second reflective layer 555B may have any thickness suitable for reflecting light. The thickness of the first reflective layer 555A and/or the second reflective layer 555B may be determined to be a value that substantially causes total reflection of light. For example, the first reflective layer 555A and the second reflective layer 555B may have a thickness of about 15 nm or less, about 12 nm or less, about 10 nm or less, about 8 nm or less, or about 5 nm or less.

The features and aspects of any embodiment(s) described above may be combined with features and aspects of any other embodiment(s) without resulting in apparent technical conflicts.

1. An aerosol generating device comprising:
a heater comprising a substrate, an enclosure disposed on the substrate, a cavity formed by the substrate and the enclosure and configured to accommodate an aerosol generating article, and a heating structure disposed on the substrate and configured to generate heat by surface plasmon resonance; and
a concentrator configured to focus light on the heating structure.

2. The aerosol generating device of claim 1, wherein the substrate comprises:
a base which defines at least a portion of the cavity; and
a flange which extends from the base.

3. The aerosol generating device of claim 1, wherein
the substrate and the enclosure comprise an opaque material.

4. The aerosol generating device of claim 1, wherein
the substrate comprises a thermally conductive material.

5. The aerosol generating device of claim 1, wherein
the substrate comprises a thermally conductive barrier material.

6. The aerosol generating device of claim 1, wherein
the heating structure comprises a plurality of metal particles applied on an outer surface of the substrate.

7. The aerosol generating device of claim 1, wherein
the heating structure comprises a metal prism comprising a plurality of metal particles.

8. The aerosol generating device of claim 7, wherein
the metal prism has a thickness greater than 0 nanometers (nm) and less than or equal to 10 nm.

9. The aerosol generating device of claim 1, wherein
the heating structure comprises a plurality of metal particles applied on a surface of the substrate and an inner surface of the enclosure.

10. The aerosol generating device of claim 1, wherein
the heater comprises a reflector disposed on an inner surface of the enclosure.

11. The aerosol generating device of claim 1, wherein
the concentrator comprises a convex lens.

12. The aerosol generating device of claim 1, further comprising:
an optical modulator configured to adjust a concentrating area of the concentrator.

13. The aerosol generating device of claim 1, further comprising:
a light source configured to emit light toward the concentrator.

14. The aerosol generating device of claim 1, further comprising:
a replaceable cartridge comprising the substrate, the enclosure, and the heating structure.

15. A cartridge for an aerosol generating article, the cartridge comprising:
a substrate;
an enclosure disposed on the substrate;
a cavity formed by the substrate and the enclosure and configured to accommodate an aerosol generating article; and
a heating structure disposed on the substrate and configured to generate heat by surface plasmon resonance.
